(19) United States
(12) Patent Application Publication
(10) Pub. No.: US 2022/0201357 A1
(43) Pub. Date: Jun. 23, 2022

(54) LIMITED-LEVEL PICTURE DETECTION METHOD, DEVICE, DISPLAY DEVICE AND READABLE STORAGE MEDIUM

(71) Applicant: SHENZHEN CHUANGWEI-RGB ELECTRONICS CO., LTD., SHENZHEN (CN)

(72) Inventor: Jun MAO, SHENZHEN (CN)

(73) Assignee: SHENZHEN CHUANGWEI-RGB ELECTRONICS CO., LTD., SHENZHEN (CN)

(21) Appl. No.: 17/254,022

(22) PCT Filed: Oct. 30, 2020
(86) PCT No.: PCT/CN2020/125557

§ 371 Date: May 11, 2021

(30) Foreign Application Priority Data
Jun. 11, 2020 (CN) 202010528446.7

(51) Int. Cl. H04N 21/441; G06V 40/10; H04N 19/44; H04N 19/172; H04N 19/85; H04N 21/44; H04N 21/4223; H04N 21/442; H04N 21/4402

(52) U.S. Cl. CPC H04N 21/441; G06V 40/10; H04N 19/44; H04N 19/172; H04N 21/4402; H04N 21/44008; H04N 21/4223; H04N 21/44218; H04N 19/85

(57) ABSTRACT

Embodiments of the present disclosure provide a limited-level picture detecting method, a limited-level picture detecting apparatus, a display device and a readable storage medium. The limited-level picture detecting method includes: carrying out soft decoding on a video source to be played in a limited mode, to obtain picture frame data of the video source; analyzing the picture frame data using a pre-established restriction characteristic model, and acquiring frame data having a limited-level image in the picture frame data; and outputting, after performing the mosaic treatment on the limited-level image of the frame data, the picture frame data of the video source.

### CROSS-REFERENCE TO RELATED APPLICATION

This application is a United States National Stage Application filed under 35 U.S.C 371 of PCT Patent Application Serial No. PCT/CN2020/125557, filed Oct. 30, 2020, which claims Chinese Patent Application Serial No. CN 202010528446.7, filed Jun. 11, 2020, the disclosure of all of which are hereby incorporated by reference in their entirety.

### TECHNICAL FIELD

The present disclosure relates to the technical field of display, and in particular, provides a limited-level picture detecting method (a limited-level picture detection method), a limited-level picture detecting apparatus (a device), a display device and a readable storage medium.

### BACKGROUND ART

With the development of Internet technologies, the display devices also become more and more intelligent, and present in a wide variety of forms to the public, and program contents also become increasingly rich. In order to prevent children from watching some unhealthy limited-level contents such as horrific, bloody and violent contents on television, some display devices introduce child lock and child mode functions.

However, once the child mode or the child lock is turned on, users generally can only watch the television contents of designated categories, and many contents will be filtered out; however, in some possible scenarios, users watching television programs include not only underage users such as children, but also include adult users, when the user watching the television interface is an adult, the television mode needs to be adjusted to the adult mode, so that the display device needs to be frequently switched between different modes, then the flexibility is relatively low, and the user experience is disrupted.

### SUMMARY

The present disclosure aims at providing a limited-level picture detecting method, a limited-level picture detecting apparatus, a display device and a readable storage medium, so as to improve the flexibility of switching different viewing modes.

In order to realize at least one of the above objectives, a technical solution adopted in the present disclosure is as follows:

An embodiment of the present disclosure provides a limited-level picture detecting method, including:

carrying out soft decoding on a video source to be played in a limited mode, to obtain picture frame data of the video source;

analyzing the picture frame data using a pre-established restriction characteristic model, and acquiring frame data having a limited-level image in the picture frame data; and

outputting, after performing mosaic treatment on the limited-level image of the frame data, the picture frame data of the video source.

Optionally, as a possible implementation, the method further includes:

controlling a camera to acquire a user image, and extracting a user body feature according to the user image; and

entering the limited mode when determining that the user is a non-adult person according to the user body feature.

Optionally, as a possible implementation, the determining that the user is a non-adult person according to the user body feature includes:

processing the user body feature using a pre-stored application configured to recognize user's age, so as to detect the user's age; and

determining that the user is a non-adult person when the user's age is lower than a preset value.

Optionally, as a possible implementation, the method further includes:

matching the user body feature with a preset user whitelist, wherein if the matching fails, the limited mode is entered.

Optionally, as a possible implementation, the method further includes:

reducing, when outputting the picture frame data having undergone the mosaic treatment, volume of corresponding audio.

Optionally, as a possible implementation, the reducing volume of corresponding audio includes:

reducing the volume of corresponding audio to a preset value.

Optionally, as a possible implementation, the performing mosaic treatment on the limited-level image of the frame data includes:

adding mosaic at a position of the limited-level image of the frame data using a preset mosaic application.

Optionally, as a possible implementation, the performing mosaic treatment on the limited-level image of the frame data includes:

performing mosaic treatment on the limited-level image of the frame data using a computer vision library OpenCV.

Optionally, as a possible implementation, the carrying out soft decoding on a video source to be played to obtain picture frame data of the video source includes:

inputting the video source to be played into a preset soft decoding application so as to obtain picture frame data of the video source.

Optionally, as a possible implementation, the restriction characteristic model includes an OpenCV characteristic model.

Optionally, as a possible implementation, the method further includes:

training the OpenCV characteristic model using updated training samples.

An embodiment of the present disclosure further provides a limited-level picture detecting apparatus, including:

a soft decoding module, configured to carry out soft decoding on a video source to be played in a limited mode to obtain picture frame data of the video source;

a frame data analyzing module, configured to analyze the picture frame data using a pre-established restriction characteristic model, and acquire frame data having a limited-level image in the picture frame data; and

a limited-level picture processing module, configured to perform mosaic treatment on the limited-level image of the frame data and then output the picture frame data of the video source.

Optionally, as a possible implementation, the apparatus further includes:

a user age recognition module, configured to control a camera to acquire a user image, and extract a user body feature according to the user image; and

a limited mode switching module, configured to enter the limited mode when determining that the user is a non-adult person according to the user body feature.

Optionally, as a possible implementation, the apparatus further includes:

a volume adjusting module, configured to reduce, when outputting the picture frame data having undergone the mosaic treatment, volume of corresponding audio.

An embodiment of the present disclosure further provides a display device, including a memory and a processor, wherein the memory is stored with a computer program, the processor runs the computer program so as to enable the display device to execute the above limited-level picture detecting method.

An embodiment of the present disclosure further provides a readable storage medium, stored with a computer program, wherein the computer program executes the above limited-level picture detecting method when running on a processor.

### BRIEF DESCRIPTION OF DRAWINGS

FIG. 1 is an exemplary flow chart of a limited-level picture detecting method provided in Embodiment 1 of the present disclosure.

FIG. 2 is another exemplary flow chart of the limited-level picture detecting method provided in an embodiment of the present disclosure.

FIG. 3 is a further exemplary flow chart of the limited-level picture detecting method provided in an embodiment of the present disclosure.

FIG. 4 is a structural schematic view of a limited-level picture detecting apparatus provided in an embodiment of the present disclosure.

FIG. 5 is another structural schematic view of the limited-level picture detecting apparatus provided in an embodiment of the present disclosure.

FIG. 6 is a further structural schematic view of the limited-level picture detecting apparatus provided in an embodiment of the present disclosure.

### DETAILED DESCRIPTION OF EMBODIMENTS

Technical solutions in the embodiments of the present disclosure will be described below clearly and completely in combination with some accompanying drawings in the embodiments of the present disclosure, and apparently, the embodiments described are only some, but not all embodiments of the present disclosure.

Generally, components in the embodiments of the present disclosure described and shown in the accompanying drawings herein may be arranged and designed in different configurations. Therefore, the detailed description below of the embodiments of the present disclosure provided in the accompanying drawings is not intended to limit the scope of protection of the present disclosure, but merely represents some exemplary embodiments of the present disclosure. Based on the embodiments of the present disclosure, all other embodiments obtained by a person skilled in the art without using creative efforts shall fall within the scope of protection of the present disclosure.

Terms such as “include”, “have” and cognates thereof used in various embodiments of the present disclosure are merely intended to indicate specific features, numbers, steps, operations, elements, components or combinations of the foregoing, and should not be construed as initially excluding the possibility of the presence of one or more other features, numbers, steps, operations, elements, components or combinations of the foregoing or the possibility of the addition of one or more other features, numbers, steps, operations, elements, components or combinations of the foregoing.

Besides, terms such as “first”, “second”, and “third” are merely for distinctive description, but should not be construed as indicating or implying importance in the relativity.

Unless otherwise defined, all terms (including technical terms and scientific terms) used herein have the same meaning as that generally understood by a person ordinarily skilled in the art of the various embodiments of the present disclosure. The terms (such as terms defined in dictionaries commonly used) shall be construed as having the same meaning as that in the context of relevant technical field and shall not be construed as having an ideal meaning or overformal meaning, unless clearly defined in the various embodiments of the present disclosure.

The present disclosure provides a display device (not shown), wherein the display device may be a smart cellphone, a tablet computer, an on-board computer, a smart wearable device, etc. The display device may include a memory and a processor, wherein the memory may be configured to store a computer program, the processor, by running the computer program, enables the display device to execute the limited-level picture detecting method provided by the present disclosure or run the functions of respective modules in the limited-level picture detecting apparatus provided by the present disclosure.

The memory may include a storage program area and a storage data area, wherein the storage program area may be configured to store an operating system, an application required for at least one function (such as a sound playing function, an image playing function), and the like; the storage data area may be configured to store data (such as audio data, a phonebook) created according to the use of the display device, and the like. Besides, the memory may include high-speed random access memory, and also may include a non-volatile memory, for example, at least one disk storage device, flash storage device, or other volatile solid-state storage devices.

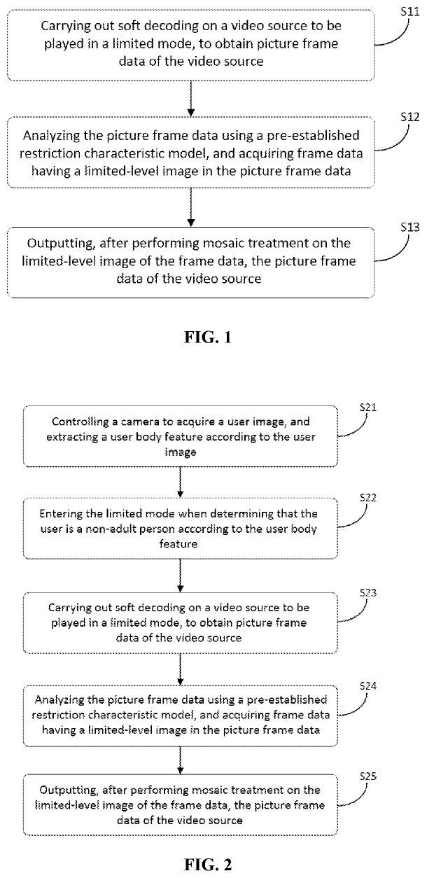

Referring to FIG. 1, FIG. 1 is an exemplary flow chart of a limited-level picture detecting method provided in Embodiment 1 of the present disclosure, wherein this method may include the following steps.

Step S11: carrying out soft decoding on a video source to be played in a limited mode, to obtain picture frame data of the video source.

In some scenarios of the embodiments of the present disclosure, display devices such as televisions become more and more intelligent, and playable contents thereof also become increasingly rich, wherein some playable contents are age-limited, and are not suitable for being played to and seen by people below a certain age. Therefore, a limited mode may be set in the display device, by which the low-age people are prevented from unintentionally seeing the limited-level contents, thus avoiding the psychological influence of the limited-level contents on the low-age people.

In some embodiments of the present disclosure, when the display device is playing a video source, the display device may perform soft decoding on the received video source, convert an analog signal into a digital signal, and then obtain a picture data frame of the video source. In the above, the soft decoding process may be implemented using an application, for example, after the display device receives the video source, the display device may input the video source into the soft decoding application in real time, so as to acquire the picture frame data of the video source.

Step S12: analyzing the picture frame data using a pre-established restriction characteristic model, and acquiring frame data having a limited-level image in the picture frame data.

In some scenarios of the embodiment of the present disclosure, after acquiring the picture frame data of the video source, the display device may analyze the picture frame data using a pre-established restriction characteristic model, so as to acquire the frame data having a limited-level image in the picture frame data. In the above, the limited-level image refers to an image containing contents that are not suitable to be seen by the low-age people, for example, bloody and violent contents.

In some embodiments of the present disclosure, the above restriction characteristic model may include an OpenCV characteristic model (OpenCV, Open Source Computer Vision Library). That is, an Open Source Computer Vision Library may be added to the display device, and a picture training algorithm is performed through the Open Source Computer Vision Library, to learn a large number of limited-level image samples, such as horrific, violent, and bloody image samples, to generate the OpenCV characteristic model, and store the OpenCV characteristic model in the display device; after obtaining the picture frame data by the soft decoding, the display device may analyze the picture frame data using the OpenCV characteristic model, so that the picture frame data having the limited-level image may be detected.

Besides, in some possible embodiments, the display device may also periodically update the training samples, so as to train the OpenCV characteristic model using the updated training samples, so that the detection accuracy of the OpenCV characteristic model is constantly improved, which is not limited in the present disclosure.

Step S13: outputting, after performing mosaic treatment on the limited-level image of the frame data, the picture frame data of the video source.

In some possible scenarios of the embodiments of the present disclosure, for the frame data having the limited-level image, the display device may perform mosaic blurring processing on the frame data having the limited-level image, for example, performing mosaic treatment on partial image areas showing, for example, violent and bloody contents, in the frame data, and then display the frame data after the mosaic treatment; in this way, in the process of displaying the picture frame data on the display device, the contents having a limited-level image will be automatically blocked by the mosaic, the adverse psychological influences of the limited-level contents on the low-age people may be effectively avoided, thereby avoiding frequent switch between different viewing modes, so as to improve the flexibility of playing.

It should be noted that, in the embodiment of the present disclosure, the above process of performing mosaic treatment on the limited-level image of the frame data may be realized using an algorithm or an application, for example, an application for mosaic treatment may be preset in the display device, and upon detection of the frame data having a limited-level image, the display device may use the application for mosaic treatment to add mosaic at a position corresponding to the frame data. In addition, in some other embodiments of the present disclosure, the display device may further perform mosaic treatment on the limited-level image of the above frame data using, for example, an OpenCV computer vision library.

Besides, on the basis of the above FIG. 1, referring to FIG. 2, FIG. 2 is another exemplary flow chart of the limited-level picture detecting method provided in an embodiment of the present disclosure, wherein this method further may include the following steps.

Step S21: controlling a camera to acquire a user image, and extracting a user body feature according to the user image.

Step S22: entering the limited mode when determining that the user is a non-adult person according to the user body feature.

In an embodiment of the present disclosure, after the display device is turned on, or a video is to be played, or during the playing of a video, the display device may control the camera to collect the user image, and extract the user body feature according to the user image, for example, the user's height, age and other features.

Exemplarily, an algorithm or an application configured to recognize user's age may be pre-stored in the display device, for example, an age recognition application may be stored in the display device, and when the display device is turned on to operate, the display device may collect the user image according to a preset time interval, and detect age of the user present using the age recognition application.

In some scenarios of the embodiments of the present disclosure, when the display device determines that the user watching the display device is a non-adult person, for example, when the age detected by the display device is lower than a preset value, the display device will enter a limited mode, and in the limited mode, the frame data having a limited-level picture will be detected, and the frame data having the limited-level picture will be subjected to the mosaic treatment. In the above, age judgment application or algorithm set in the display device is not limited herein.

In an embodiment of the present disclosure, after the user body feature is extracted, the display device may further match the user body feature with a pre-stored user whitelist, and if the matching succeeds, it is indicated that the user is a whitelist user, then the limited mode is not entered; and if the matching fails, the limited mode is entered. Alternatively, when the body features of many users are recognized, if one of them is a whitelist user, the limited mode is not entered. The body features of the whitelist users of the display device may be input by the users, and also may be obtained by receiving input from other devices, which is not limited herein.

Step S23: in the limited mode, carrying out soft decoding on a video source to be played to obtain picture frame data of the video source.

This step is consistent with the above step S11, and is not repeated herein again.

Step S24: analyzing the picture frame data using a pre-established restriction characteristic model, and acquiring the frame data having a limited-level image in the picture frame data.

This step is consistent with the above step S12, and is not repeated herein again.

Step S25: outputting, after performing mosaic treatment on the limited-level image of the frame data, the picture frame data of the video source.

This step is consistent with the above step S13, and is not repeated herein again.

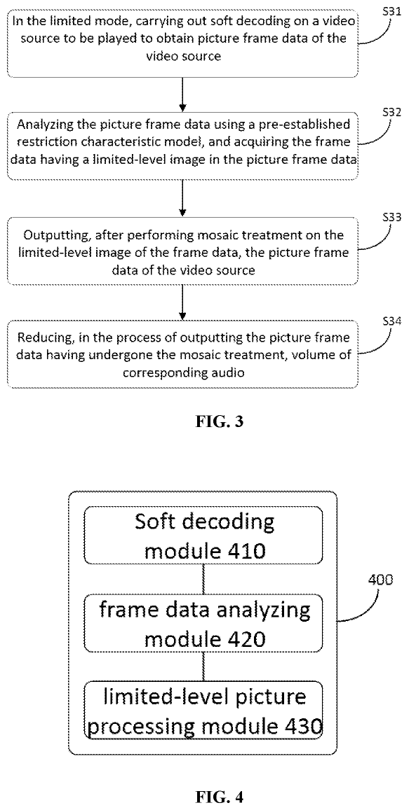

Besides, on the basis of the above FIG. 1, referring to FIG. 3, FIG. 3 is a further exemplary flow chart of the limited-level picture detecting method provided in an embodiment of the present disclosure, wherein this method further may include the following steps:

Step S31: in the limited mode, carrying out soft decoding on a video source to be played to obtain picture frame data of the video source.

This step is consistent with the above step S11, and is not repeated herein again.

Step S32: analyzing the picture frame data using a pre-established restriction characteristic model, and acquiring the frame data having a limited-level image in the picture frame data.

This step is consistent with the above step S12, and is not repeated herein again.

Step S33: outputting, after performing mosaic treatment on the limited-level image of the frame data, the picture frame data of the video source.

This step is consistent with the above step S13, and is not repeated herein again.

Step S34: reducing, in the process of outputting the picture frame data having undergone the mosaic treatment, volume of corresponding audio.

In some scenarios of the embodiments of the present disclosure, during the process of outputting the picture frame data having undergone the mosaic treatment, that is, during the process of playing the frame data having the limited-level picture, the display device may further reduce the volume of the corresponding audio when outputting the picture frame data, for example, reduce the volume of the audio to a preset value. In the above, in some possible scenarios, if an initial volume value of the display device is lower than the preset value, no adjustment may be made. In addition, in the process of playing other frame data having no limited-level picture, the display device may automatically restore the volume to the initial value, thereby improving the user's experience.

In addition, based on the same inventive concept as the above limited-level picture detecting method provided in the embodiment of the present disclosure, referring to FIG. 4, FIG. 4 is a structural schematic view of a limited-level picture detecting apparatus provided in an embodiment of the present disclosure.

This limited-level picture detecting apparatus 400 may include:

a soft decoding module 410, which may be configured to carry out soft decoding on a video source to be played in a limited mode to obtain picture frame data of the video source;

a frame data analyzing module 420, which may be configured to analyze the picture frame data using a pre-established restriction characteristic model, and acquire frame data having a limited-level image in the picture frame data; and

a limited-level picture processing module 430, which may be configured to perform mosaic treatment on the limited-level image of the frame data and then output the picture frame data of the video source.

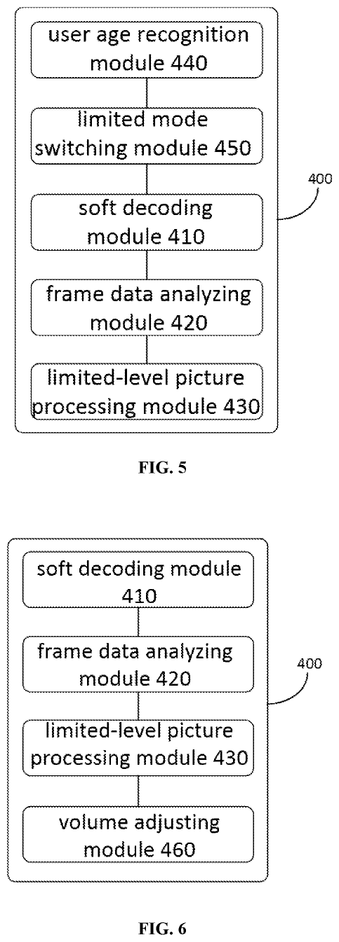

In another possible embodiment, as shown in FIG. 5, this limited-level picture detecting apparatus 400 further may include:

a user age recognition module 440, which may be configured to control a camera to acquire a user image, and extract a user body feature according to the user image; and

a limited mode switching module 450, which may be configured to enter the limited mode when determining that the user is a non-adult person according to the user body feature.

In a possible embodiment, as shown in FIG. 6, this limited-level picture detecting apparatus 400 further may include:

a volume adjusting module 460, which may be configured to reduce, in the process of outputting the picture frame data having undergone the mosaic treatment, volume of corresponding audio.

It may be understood that, for the convenience and simplicity of description, in the embodiments of the present disclosure, reference may be made to the contents of corresponding parts in the foregoing embodiments for further detailed description of functions of respective modules above, and details are not described herein again.

An embodiment of the present disclosure further provides a computer storage medium, configured to store a computer program used in the above display device.

In the several embodiments provided in the present disclosure, it should be understood that the apparatus and the method disclosed further may be implemented in other manners. The apparatus embodiments described above are merely exemplary, for example, the flow charts and the structural views in the accompanying drawings show possible system structures, functions and operations of the apparatus, method, and computer program product according to multiple embodiments of the present disclosure. In this regard, each block in the flow charts or the block views may represent a part of one module, program segment or code, and the part of the module, the program segment or the code contains one or more executable instructions configured to achieve a specified logical function.

It also should be noted that in some implementations as substitutions, the functions indicated in the blocks also may proceed in an order different from that indicated in the accompanying drawings. For example, two continuous blocks practically may be executed substantially in parallel, and they sometimes also may be executed in a reverse order, which depends upon the functions involved.

It also should be noted that each block in the structural views and/or flow charts, and combinations of the blocks in the structural views and/or the flow charts may be realized by a dedicated hardware-based system configured to execute a specified function or action, or may be realized by a combination of dedicated hardware and computer instructions.

Besides, the various functional modules or units in the embodiments of the present disclosure may be integrated together to form one independent portion, and it is also possible that the various modules exist independently, or that two or more modules are integrated to form one independent part.

If the function is realized in a form of software functional module and is sold or used as an individual product, it may be stored in one computer readable storage medium. Based on such understanding, the technical solutions in essence or parts making contribution to the prior art or parts of the technical solutions of the present disclosure may be embodied in form of a software product, and this computer software product is stored in a storage medium, including several instructions for making one computer device (which can be smart cellphone, a personal computer, a server or a network device etc.) execute all or part of the steps of the method of the embodiments of the present disclosure. The aforementioned storage medium includes various media in which program codes may be stored, such as U disk, mobile hard disk, Read-Only Memory (ROM), Random Access Memory (RAM), diskette and compact disk.

The above-mentioned are merely some exemplary embodiments of the present disclosure, but the scope of protection of the present disclosure is not limited thereto, and changes and substitutions that may be easily envisaged by a person skilled in the present art within the technical scope disclosed in the present disclosure should fall within the scope of protection of the present disclosure. Therefore, the scope of protection of the present disclosure should be determined by the scope of protection of the claims.

### INDUSTRIAL APPLICABILITY

By carrying out the soft decoding on the video source to be played in the limited mode, to obtain the picture frame data of the video source; analyzing the picture frame data using a pre-established restriction characteristic model, and acquiring frame data having a limited-level image in the picture frame data; and then outputting the picture frame data of the video source after performing mosaic treatment on the limited-level image of the frame data. In this way, in the process of displaying the picture frame data on the display device, the contents having the limited-level image will be automatically blocked by the mosaic, and frequent switch between different viewing modes may be effectively avoided, so as to improve the flexibility of playing.

1. A limited-level picture detecting method, comprising:
carrying out soft decoding on a video source to be played in a limited mode, to obtain picture frame data of the video source;
analyzing the picture frame data using a pre-established restriction characteristic model, and acquiring frame data having a limited-level image in the picture frame data; and
outputting, after performing a mosaic treatment on the limited-level image of the frame data, the picture frame data of the video source.

2. The limited-level picture detecting method according to claim 1, wherein the method further comprises:
controlling a camera to acquire a user image, and extracting a user body feature according to the user image; and
entering the limited mode, when determining that a user is a non-adult person according to the user body feature.

3. The limited-level picture detecting method according to claim 2, wherein the determining that a user is a non-adult person according to the user body feature comprises:
processing the user body feature using a pre-stored application configured to recognize an age of a user, so as to detect the age of the user; and
determining that the user is a non-adult person, when the age of the user is lower than a preset value.

4. The limited-level picture detecting method according to claim 2, wherein the method further comprises:
matching the user body feature with a preset user whitelist, and if the matching fails, entering the limited mode.

5. The limited-level picture detecting method according to claim 1, wherein the method further comprises:
reducing, when outputting the picture frame data having undergone the mosaic treatment, volume of corresponding audio.

6. The limited-level picture detecting method according to claim 5, wherein the reducing volume of corresponding audio comprises:
reducing the volume of corresponding audio to a preset value.

7. The limited-level picture detecting method according to claim 1, wherein the performing a mosaic treatment on the limited-level image of the frame data comprises:
adding mosaic at a position of the limited-level image of the frame data using a preset mosaic application.

8. The limited-level picture detecting method according to claim 1, wherein the performing a mosaic treatment on the limited-level image of the frame data comprises:
performing the mosaic treatment on the limited-level image of the frame data using a computer vision library OpenCV.

9. The limited-level picture detecting method according to claim 1, wherein the carrying out soft decoding on a video source to be played to obtain picture frame data of the video source comprises:
inputting the video source to be played into a preset soft decoding application, so as to obtain the picture frame data of the video source.

10. The limited-level picture detecting method according to claim 1, wherein the restriction characteristic model comprises an OpenCV characteristic model.

11. The limited-level picture detecting method according to claim 10, wherein the method further comprises:
training the OpenCV characteristic model using updated training samples.

12. A limited-level picture detecting apparatus, comprising:
a soft decoding module, configured to carry out soft decoding on a video source to be played in a limited mode, to obtain picture frame data of the video source;
a frame data analyzing module, configured to analyze the picture frame data using a pre-established restriction characteristic model, and acquire frame data having a limited-level image in the picture frame data; and
a limited-level picture processing module, configured to perform mosaic treatment on the limited-level image of the frame data and then output the picture frame data of the video source.

13. The limited-level picture detecting apparatus according to claim 12, wherein the apparatus further comprises:
a user age recognition module, configured to control a camera to acquire a user image, and extract a user body feature according to the user image; and
a limited mode switching module, configured to enter the limited mode when determining that a user is a non-adult person according to the user body feature.

14. The limited-level picture detecting apparatus according to claim 12, wherein the apparatus further comprises:
a volume adjusting module, configured to reduce, when outputting the picture frame data having undergone the mosaic treatment, volume of corresponding audio.

15. A display device, comprising a memory and a processor, wherein a computer program is stored in the memory, the processor runs the computer program, so as to enable the display device to execute the limited-level picture detecting method according to claim 1.

16. (canceled)

17. The limited-level picture detecting method according to claim 2, wherein the method further comprises:
reducing, when outputting the picture frame data having undergone the mosaic treatment, volume of corresponding audio.

18. The limited-level picture detecting method according to claim 2, wherein the performing a mosaic treatment on the limited-level image of the frame data comprises:
adding mosaic at a position of the limited-level image of the frame data using a preset mosaic application.

19. The limited-level picture detecting method according to claim 2, wherein the performing a mosaic treatment on the limited-level image of the frame data comprises:
performing the mosaic treatment on the limited-level image of the frame data using a computer vision library OpenCV.

20. The limited-level picture detecting method according to claim 2, wherein the carrying out soft decoding on a video source to be played to obtain picture frame data of the video source comprises:
inputting the video source to be played into a preset soft decoding application, so as to obtain the picture frame data of the video source.

21. The limited-level picture detecting method according to claim 2, wherein the restriction characteristic model comprises an OpenCV characteristic model.
